(19) United States
(12) Patent Application Publication
(10) Pub. No.: US 2007/0176344 A1
(43) Pub. Date: Aug. 2, 2007

(54) Insulation for the continuous treatment of a textile web of fabric, and method for operating said installation

(76) Inventors: Roland Hampel, Ubach-Palenberg (DE); Ernst Klas, Monchengladbach (DE)

Correspondence Address: WILLIAM COLLARD;COLLARD & ROE, P.C., 1077 NORTHERN BOULEVARD, ROSLYN, NY, 11576, US

(21) Appl. No.: 10/590,754

(22) PCT Filed: Mar. 5, 2005
(86) PCT No.: PCT/DE05/00385

§ 371 Date: Aug. 25, 2006

(30) Foreign Application Priority Data
Apr. 2, 2004 (DE) 10 2004 016 302.2

(51) Int. Cl. B25C 7/00

(52) U.S. Cl. 269/289 R; 227/154

(57) ABSTRACT

The invention relates to an installation for continuous treatment of a textile web of fabric (1) which has free longitudinal edges (2) and is stretched in the longitudinal direction (3), the longitudinal edges (2) of the web of fabric (1) being prevented from turning back by staples (8). In order to mechanize the application of the staples (8), a staple gun (17) comprising a staple magazine (15) is associated with the respective longitudinal edge (2) at a point on the installation at which the edge is not normally turned back yet.

The invention relates to a system for continuous treatment, such as dyeing, drying, steaming or fixation of a textile web of fabric that has free longitudinal edges and is guided stretched in the longitudinal direction of the web, particularly of woven or knitted goods, in which turning over of the longitudinal edges is suppressed by means of placement of staples, using staple fingers that lie alternately on the two web surfaces, next to one another in the plane of the web. The invention furthermore relates to a method for operation of the system.

The longitudinal edges of the web that is stretched longitudinally can turn over, for example flip over or roll in, if they are not—as is presupposed here—held in place, for example on a chain that runs with them. This turning over of the longitudinal edges of the web of fabric occurs with web goods of very different types, for example in the case of both woven goods and knitted goods. The edges can turn over particularly easily if the web has defects and/or consists of knitted goods. Within the present scope, the term “turn over” includes any type of flipping over, rolling in or starting to roll in, or flipping over of the free longitudinal edges of a web of fabric (as indicated above).

On a major portion of the web length, turning in of the edges—particularly in the case of knitted goods—can be effectively prevented by gluing the edges. A corresponding method that relates to continuous dyeing is described in DE 101 31 00 A1. However, this known method is often not effective in the regions of the web length in which the longitudinal tension that acts in the web is not uniform, due to defects at the edge or in the web surface, or due to a seam. There, the web can become wavy. Then the edge of the web can turn over (often at both web edges).

For this reason, up until now, staples—for example, staples consisting of “pertinax”—are placed over the web edge (in the direction crosswise to the transport direction), at the locations of the web that are at risk. Such staples can possess three fingers connected by means of a staple back and having a length of approximately 10 cm, whereby the middle finger is supposed to lie on the one web surface and the two lateral fingers are supposed to lie on the other web surface. The edge cannot turn over in the region of such a staple. If necessary, a staple is placed onto opposite edges from the side, in each instance. A web that has been edge-stabilized in this manner, using one or more staples, runs through the treatment machine, in each instance, for example a hot flue, with the staples, and is then passed to the next treatment step, rolled up or laid down. At the exit from the machine, i.e. before the web is rolled up, the staples can be pulled off the edge again, or they can remain in place.

Placement of the staples generally requires additional personnel, because placement must occur before the web edge has permanently turned over, and because placement must often take place from both web edges, practically at the same time. Removal of the staples at the exit from the machine can be important if the staples would be disruptive during a subsequent treatment cycle.

The invention is based on the task of mechanizing the handling, particularly placement, of the staples, and of being able to activate it by remote control, for example from the console of the machine operator.

The solution according to the invention is described for the system indicated initially, in the characterizing part of claim 1. It is particularly characterized by a staple-shooting device with a staple magazine, which is assigned to the longitudinal edge, in each instance, at a location of the system in which the edge has normally not turned over yet. Some improvements and further embodiments of the invention are described in the other claims.

Preferably, the solution according to the invention consists in the fact that a staple shooting device with a staple magazine is disposed ahead of the entrance of the treatment machine, in each instance, at a location at which the edge, which tends to turn in—also in problematical regions, for example seams or defects—normally has not turned over yet. The staple-shooting device can preferably consist of a slide or plunger, which pushes or shoots a staple that is situated in the chamber in the direction of the edge that is at risk.

If the fingers or tines of the staple in question must be spread apart, for example bent away from one another, before being placed onto the web edge, the staple should pass through a spreading device on its way to the web edge, in which device the staple fingers that lie next to one another are spread open for placement onto the web edge—in other words alternately over the plane of the one and the other web surface—so that adjacent fingers alternately come to lie on the one and on the other web surface. The effect of this spreading device can be cancelled out once the fingers have passed the edge itself. The staple should generally be shot as far as possible onto the web, namely until contact of the web edge on the lip back occurs between two fingers, in each instance. The part of the spreading device that spreads the finger, in each instance, should be mounted in resilient manner, so that it can escape as the staple back passes.

Such a spreading device can be eliminated if the staple in question can be placed onto the edge of the web of fabric even without special spreading, and nevertheless remains firmly in place—even when running over rollers—in the subsequent treatment machine. This applies, for example, for a staple with a slit between the (spread) fingers/tines that narrows conically or in wedge shape, or for a staple whose spread tines snap together after they impact or strike the edge of the web of fabric.

In order to achieve secure and complete placement of the staple, in each instance, it can be advantageous to guide the web of fabric, and particularly its edge region—at least where placement is supposed to occur—precisely and without flutter. This applies, in particular, if a staple with tines that are permanently spread in slightly conical manner is supposed to be used.

Stapling preferably takes place at such a high speed that one can speak of shooting the staple on. In particular, the shoot-on speed that occurs in a direction crosswise to the web transport direction is supposed to be so great, relative to the transport speed, that no waves of any kind are formed in the web when the staple is placed. If the shoot-on speed or the transport speed have a ratio of 10:1 or more, this condition is generally met. In this connection, it should be noted that traditionally, when the staple was placed by hand, the operator could follow the web movement when placing it. In the case of the device according to the invention, this following movement can be eliminated if the placement is carried out quickly enough.

In order to achieve the result that the individual staple is placed onto the web edge as completely as possible (for example until it makes contact between the fingers), it can be necessary to position the staple-shooting device at a fixed distance (or distance range) from the web edge. In case of lateral progression of the web (this means a movement crosswise to the transport direction), the shooting device should therefore be able to follow. The same holds true for the case of changing widths of the web of fabric. Following can be controlled by means of an edge sensor or by hand, and can be brought about using an adjustment spindle, for example.

To active the slide of the staple shooting device, a hydraulic or pneumatic cylinder or a catapult, preferably with a mechanical spring, can be provided. Activation, in each instance, is supposed to be able to take place by remote control, preferably also by means of manual triggering. For example, if the machine operator sees a wavy region in the web surface from his/her position, and must fear that turning over of the web edge will occur, he/she can place a staple onto one or both web edges (also from his/her location).

The staple can remain in place on the web edge after it has left the treatment machine, in each instance, more or less as a disposable item. However, it might also be desirable to pull the staples, which have fulfilled their purpose, off from the edge again at the exit of the treatment machine in question. For this purpose, according to a further invention, a staple pulling device, preferably an automatically acting device, can be used, with a corresponding configuration of the individual staples themselves.

Each staple possesses not only the staple fingers but also a staple back with an abutment edge that lies opposite the fingers; this is the edge on which a slide, for example, makes contact when the staple is shot in. The staple back furthermore possesses two side edges that extend essentially in the longitudinal direction of the fingers, namely a front and a rear side edge.

According to a further invention, it is proposed to provide a notch in the front side edge, preferably also in the rear side edge, and to place a pin (preferably standing perpendicular to the plane of the web) fixed in place relative to the web edge, at the position of the system at which the staple is supposed to be pulled off, in such a manner that the staple, which runs past with the web, hooks into the notch on the pin. The pin—similar to the shooting device—can be configured to follow a lateral progression of the web, or for the case of changing widths of the web of fabric.

The aforementioned notch in the front side edge of the staple, in each instance, should be formed in such a manner, and the pin should be positioned in such a manner that the pin, which is fixed in place at that moment, holds, i.e. captures the staple and (automatically) pulls it off the web, which continues to run.

Preferably, the pin is placed so far away from the web edge, in each instance, that the staple that remained hanging on the pin can fall to the floor or into a collection container to the side of the web. It is practical if in each staple, a notch is provided in its front side edge and its rear side edge, in each instance, especially if insertion of the staple into the magazine, in each instance, is simplified thereby. The notch should be formed in such a manner that even if the staples or pins are pleced imprecisely, the staple in question is reliably seized and pulled by the pin.

If the staples simply fall into a container after being pulled, it can be tedious to organize them and to deposit them into the magazine of the staple-shooting debice in orderly manner. For this reason, it is proposed, according to a further invention, to collect the pulled staples in a funnel and to guide them into a magazine container by way of a slide or the like, in directed manner. In this connection, advantage is taken of the fact that staples that are pulled at the same location and in the same manner will normally fall down in the same direction. In the funnel, the dropping staples are oriented, so that they reach a magazine container in the same direction, with the help of a slide. Once the magazine container is full, it can be brought to the staple-shooting device—for example by hand—and replaced with an empty container.

In order to achieve the result, during sorting of the released staples into the magazine, that the staple fingers of all the staples are oriented in the same direction, it can be advantageous to configure the magazine container in such a manner that the staples can be positioned only in one orientation (the fingers to one side, the staple backs to the other side). This can be achieved, for example, by means of the shaping of the staple and a corresponding shape of the magazine interior. For example, the adjacent fingers of a staple can have alternately different lengths. If, for example, a three-finger staple possesses two short outer fingers and a somewhat longer middle finger, the inner contour of the magazine container can easily be shaped in such a manner that each staple can lie flat in the magazine only in one orientation.

The machine operator can set the staples, using the shooting device according to the invention, by eye. For further automation, an edge sensor can be provided, which detects turned-over edges or edge regions—possibly in combination with a width-stretching device—and activates the width-stretching device if necessary. A staple can then be placed onto a web edge that has been made smooth in this manner.

An edge sensor for detecting edges that have turned over can be provided, with particular advantage, also within the treatment machine, in each instance. After all, the machine operator cannot (directly) see damage that might be getting ready to occur there. If the edge sensor detects turning over of an edge within the machine, for example in the hot region of a hot flue, it can place one or more staples in the region before the entry into the machine, so that the turning over does not continue randomly. Such an edge sensor should be place outside and inside of the machine, particularly wherever there is a risk that the edge will turn over and/or where the machine operator can only observe poorly or not at all.

Details of the invention are explained using the schematic drawing of exemplary embodiments. This shows:

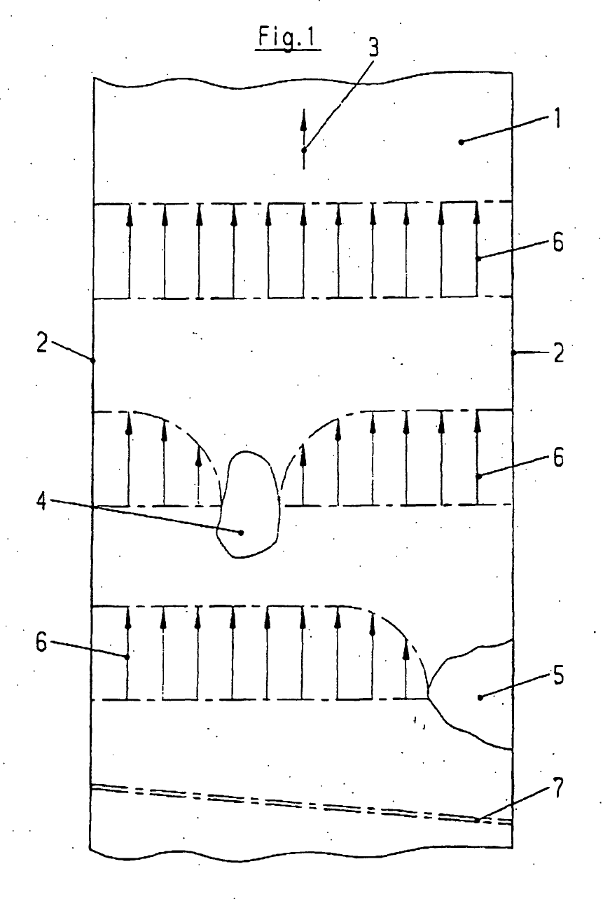

FIG. 1 a piece of a web of fabric stretched in the longitudinal direction, with non-uniform tension in the longitudinal direction of the web of fabric, according to defects or a seam;

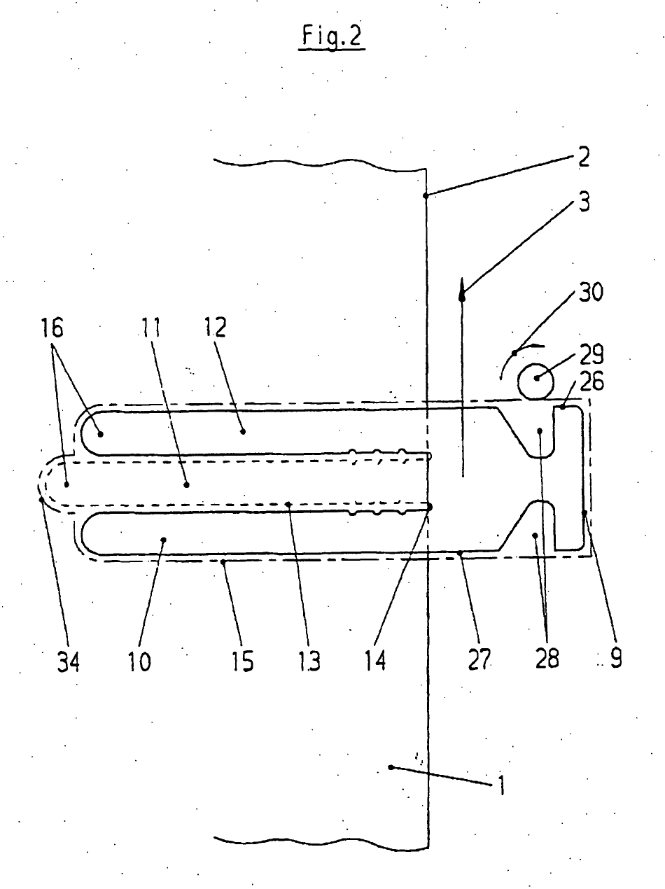

FIG. 2 a staple that has been placed onto an edge of the web of fabric;

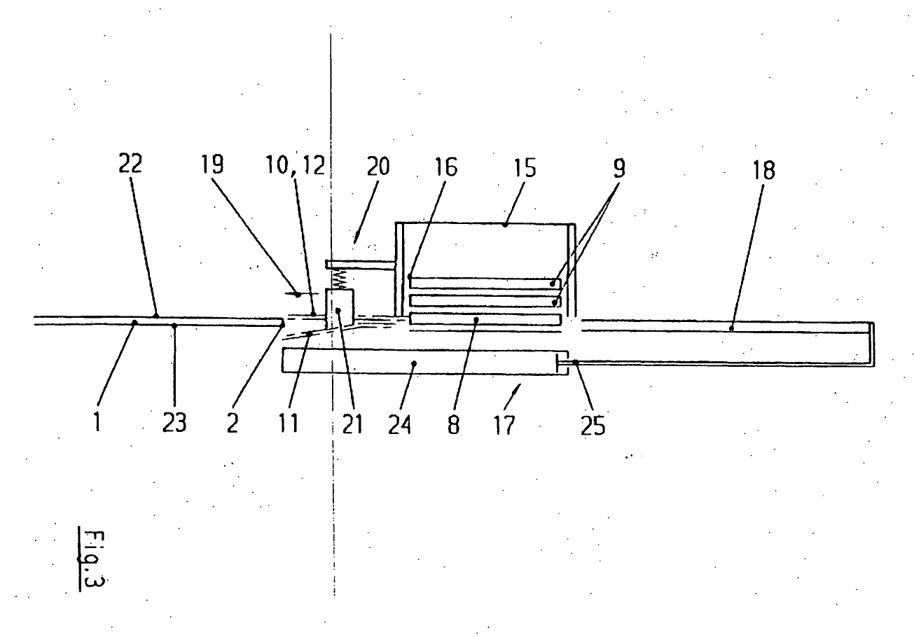

FIG. 3 a staple shooting device with magazine; and

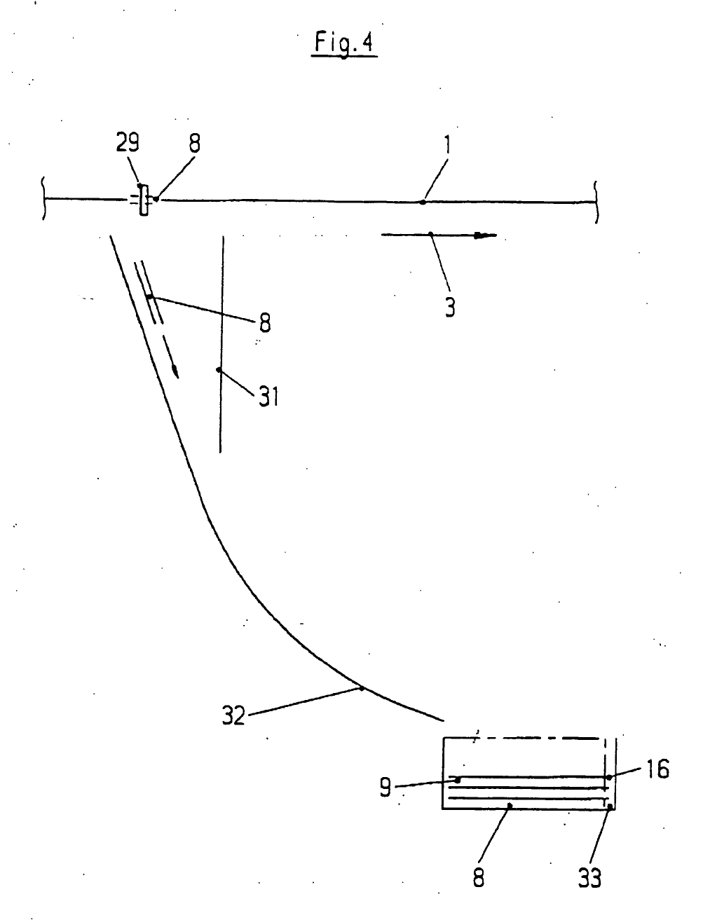

FIG. 4 a staple collection device.

If a web of fabric 1 is pulled in the transport direction 3, without being held at its web edges, i.e. longitudinal edges 2, between two rollers (not shown), stretched in the longitudinal direction, the edges 2 can turn over, for example as the result of defects 4 in the middle or 5 at the edge, which result from production errors or sample-taking, for example. This is due to the fact that the uniform distribution of the tension, symbolized by the arrows 6, in the case of a web 1 that is undamaged and uniformly stable everywhere, becomes non-uniform in the region of a defect 4 or 5. The non-uniform distribution of tension (in the longitudinal direction of the web) can result in longitudinal waves in the web and therefore in turning over of the edges 2. A seam 7 that is present in the web can have an effect that is similar in its end result.

Such turning over of the longitudinal edges 2 as the result of non-uniform distribution of the tension occurs in the case of textile webs of fabric of very different types, for example in the case of both woven goods and knitted goods. In the case of knitted goods, the risk that the edges 2 will roll in is particularly great, therefore in this case, the edges are generally stiffened, for example by means of gluing. However, such stiffening by means of gluing the edges is often not sufficient, even in the case of woven goods, to prevent the edges from turning over if the defects 4 and 5 as described or seams are present in the web. In order to prevent this turning over, a staple indicated as a whole as 8 is placed onto the edge 2, which staple possesses staple fingers 10, 11, and 12 that sit on a staple back 9—generally in one plane and separated by incisions 13—in the exemplary embodiment 3.

In the exemplary embodiment according to FIG. 2, it is assumed that the outer fingers 10 and 12 lie on the web of fabric 1 shown in the drawing, and that the center finger 11 lies against the surface underneath the web of fabric. The staple 8 according to FIG. 2 is placed onto the web of fabric 1 until contact 14 occurs between the fingers 10 and 12, on the staple back 9. A staple having two tines disposed on top of one another in the direction perpendicular to the plane of the web of fabric would be placed onto the web edge in similar manner. The tines could be pre-spread, for example.

FIG. 3 shows the principle of a staple-shooting device according to the invention. The staples 8 made available to be shot onto the edge 2 of a web of fabric 1 lie in a magazine 15, in orderly manner. The magazine 15 is made to face the web edge 2, oriented in such manner that the finger tips 16 are facing the web edge and the staple backs 9 are facing away from the web edge.

A shooting device or catapult, designated as a whole as 17, is assigned to the magazine 15. The shooting device possesses a plunger or striking pin 18 that strikes against the staple back 9 of one of the staples 8 of the magazine 15 and accelerates the staple out of the magazine in the crosswise direction 19 (direction crosswise to the transport direction 3 towards the web edge 2).

If necessary, the moved staple 8 passes by a spreading device 20 on its way to the web edge 2, which device pushes a deflection surface 21, which is preferably—as shown in FIG. 1—resiliently mounted, into the path of the staple 8, which surface—in the exemplary embodiment (FIG. 2)—presses the middle finger 11 down out of the plane of the staple (fingers 10 and 12), so that the staple impacts the web edge 2 with spread fingers on its further path. During the further movement of the staple 8, the fingers 10 to 12 leave the region of effect of the spreading device 20, so that they finally come to rest flat against the upper and lower side 22 and 23 of the web of fabric 1. As the staple back 9 slides by, the resilience of the deflection surface 21 gives way.

As shown, a pneumatic cylinder 24 can be provided as a shooting device 17, the piston 25 of which is connected with the plunger or striking pin 18. When the piston 25 is moved out of the position shown in FIG. 3 into the opposite position in the cylinder 24, the striking pin 18 pushes a staple 8 out of the magazine 15 onto the web of fabric 1.

If the staple 8, in each instance, is supposed to be pulled off the web of fabric 1 automatically once it has fulfilled its task, a staple-pulling device can be used, as is evident from FIG. 2 and 4. According to FIG. 2, notches 28 are provided in the staple back 9, in the front side edge 26 and preferably also in the rear side edge 27. In the exemplary embodiment, the side edges 26, 27 have a length of approximately 4 cm (with fingers 10 to 12 having a length of approximately 10 cm). The notches 28 are formed in such a manner that a pin 29 that is provided and fixed in place at the position where the staple 8 is supposed to be pulled hooks into the notch 28 of the staple 8 that is moving in the transport direction 3. The staple 8 is held in place by the pin 29, which preferably stands perpendicular to the plane of the web, and is generally pulled off the web of fabric 1, with a rotation about the pin 29, in the pivoting direction 30.

The staple 8 can then drop to the floor or into a container or, alternatively, can be passed to a magazine container 33 by means of a funnel 31 and a slide 32. The magazine container 33 can be configured in such a manner that the staples 8 can lie flat on top of one another only in a direction that is the same for all the staples. For example, in FIG. 4 it is assumed that the only possible smooth position of the staples in the magazine container 33 is possible if the finger tips 16 point to the right and the staple backs 9 point to the left. This selected position can be achieved if the interior of the magazine container 33, which is shown with a broken line in FIG. 2, possesses a bulge 34 at the tip 16 of the middle finger 11.

### REFERENCE SYMBOL LIST

1=web of fabric
2=web edge
3=transport direction
4=defect, center
5=defect, edge
6=tension
7=seam
8=staple
9=staple back
10-12=staple fingers
13-incision
14=contact
15=magazine
16=finger tip
17=shooting device
18=striking pin
19=crosswise direction
20=spreading device
21=deflection surface
22=upper side
23=lower side
24=pneumatic cylinder
25=piston
26=front edge
27=rear edge
28=notch
29=pin
30=pivoting direction
31=funnel
32=slide
33=magazine container
34=bulge

1. System for continuous treatment, such as dyeing, drying, steaming or fixation of a textile web of fabric (1) that has free longitudinal edges (2) and is guided stretched in the longitudinal direction (3) of the web, in which turning over of the longitudinal edges (2) is suppressed by means of placement of staples (8), using staple fingers (10 to 12) that lie alternately on the two web surfaces (22, 23), next to one another in the plane of the web of fabric (1), wherein a staple shooting device (17) with a staple magazine (15), which is assigned to the longitudinal edge (2), in each instance, at a location of the system in which the edge normally has not turned over yet.

2. System according to claim 1, wherein the staple shooting device (17) consists of a staple slide or striking pin (18) for shooting the staple (8) out in the direction (19) of the web edge (2), assigned to a staple position in the magazine (15).

3. System according to claim 1, wherein a pneumatic or hydraulic cylinder (24) is provided for activating the slide or striking pin (18).

4. System according to claim 1, wherein a catapult, preferably one that is biased mechanically, is provided for activating the slide or striking pin (18).

5. System according to claim 1, wherein effective means (21) of a staple spreading device (17) for spreading adjacent staple fingers (10 to 12) alternately towards the upper and lower side (22, 23) of the web of fabric (1), before placement onto the longitudinal edge (2).

6. System according to claim 1, wherein manual activation of the staple shooting device (17), preferably from a distance, for example from the console of the machine operator, is provided.

7. System according to claim 1, wherein automatic activation of the staple-shooting device (17) by means of an edge sensor is provided.

8. System according to claim 1, wherein the staple back (9) possesses a notch (28) at least on its front side edge (26, 27), and that a pin (29) is set in fixed manner at a distance from the longitudinal edge (2), for automatic pulling of the staple (8), which pin engages into the notch
(28) as the staple (8) passes by, and holds the staple (8) in place as well as pulls if off the web (1).

9. System according to claim 8, wherein the staple (8) automatically pulled off the web (1) gets into a magazine (15) by way of a funnel (31) and a slide (32), ordered in oriented manner.

10. System according to claim 1, wherein means, preferably sensor-controlled means, are provided for allowing follow of the staple shooting device (17) and/or the pin (29) in case of lateral progression of the web (1)—progression crosswise to the transport direction (3)—or in case of changing web widths.

11. Method for operating the system according to claim 1, wherein shooting of the staple (8) onto the edge (2), in a direction (19) crosswise to the web transport direction (3), takes place at a greater speed as compared with the transport speed.

12. Method according to claim 11, wherein placement of the staple (8), in each instance, takes place until contact (14) occurs between two fingers (10 to 12) on the staple back (9).
